(19) United States
(12) Patent Application Publication
(10) Pub. No.: US 2009/0295175 A1
(43) Pub. Date: Dec. 3, 2009

(54) Case Latch Assembly

(75) Inventor: James Hatton, St. Leonards-On-Sea (GB)

Correspondence Address: John T. Headley;Law Offices Of Tim Headley, 7941 Katy Fwy., Suite 506, Houston, TX, 77024-1924, US

(73) Assignee: Penn Fabrication Ltd, St. Leonards-On-Sea (GB)

(21) Appl. No.: 12/323,180

(22) Filed: Nov. 25, 2008

(30) Foreign Application Priority Data
Nov. 26, 2007 (EP) 07121498.5

(51) Int. Cl. E05C 3/04

(52) U.S. Cl. 292/203

(57) ABSTRACT

A case latch assembly 10 comprises a catch plate 12, a latch slider 14, a latch body 16, latch actuation means 18, a latch dish 20, a latch dish front 22 and a latch guard 24. The latch slider 14 comprises a slider body 26, latch arm 28 and a latch hook 30. The latch hook 30 comprises a hook member 32 and a latch hook ramp 34. The latch body 16 is provided with a latch aperture 40 and a latch actuation ramp 42, adapted to engage the latch hook ramp 34. In operation, the latch hook ramp 34 is pushed towards and engages against the latch actuation ramp 42, which pushes the latch hook 30 through the latch aperture 40 along an angled, downwards path away from the latch body 16. The latch hook 30 is thereby fully disengaged from and removed from the catch plate 12.

### CROSS-REFERENCES TO RELATED APPLICATIONS

This patent application claims the priority benefit of European Patent Application Number 07121498.5, filed Nov. 26, 2007, entitled “Case Latch Assembly”, and listing as the inventor James Hatton.

### STATEMENT REGARDING FEDERALLY SPONSORED RESEARCH OR DEVELOPMENT

None.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

None.

### BACKGROUND OF THE INVENTION

(1) Field of the Invention

The invention relates to a case latch assembly.

(2) Description of the Related Art

Conventional butterfly latches comprise a latch hook mounted on a slider, which is movably mounted on a hinge plate, which in turn is hingedly mounted on one (large) half of a split dish. A cam is provided between the hinge plate and the slider, and is manually operated via a key handle to cause the slider to move in and out of the hinge plate. A catch plate is provided on the other (small) half of the split dish. The split dish is externally mounted on the body (large half) and lid (small half) of a case. The latch hook is adapted to hook onto the catch plate, and holds the case closed; the hinge plate is spring mounted so tension is provided to hold the latch, and thus the case, closed. To open the latch, the key handle is turned, which via the cam, causes the slider to extend out of the hinge plate. Once the latch hook has been moved out of engagement with the catch plate, the hinge plate is then rotated so the slider and latch hook swing up and away from the catch plate to allow the case to be opened. A problem associated with conventional case latches is that they are mounted externally on the case which they are being used to lock, and are therefore exposed to damage and tampering.

### BRIEF SUMMARY OF THE INVENTION

According to a first aspect of the invention there is provided a case latch assembly comprising:
a catch plate;
a latch slider comprising a latch arm and a latch hook provided at the distal end thereof, and resilient biasing means adapted to retain the latch hook in a closed position, in which the latch hook can engage the catch plate;
a latch body adapted to receive at least part of the latch slider; and
latch actuation means operable to cause the latch hook to move between the closed position and an open position in which the latch hook is removed from the catch plate,
   characterised in that the latch hook comprises a hook member adapted to engage the catch plate and coupled to the latch arm by a latch hook ramp, and
   the latch body is provided with a latch aperture through which the latch hook is at least partly received and a latch actuation ramp provided generally across the latch aperture and adapted to engage the latch hook ramp,
   such that as the latch hook is moved from the closed position towards the open position the latch hook moves through the latch aperture and the latch actuation ramp engages the latch hook ramp and forces the latch hook to follow an angled path away from the latch body.

The case latch assembly can therefore be unlocked/opened simply by operating the latch actuation means, which fully disengages the latch hook from the catch plate and moves the latch hook to a position in which the case is free to open; unlike conventional case latches, the slider of the present invention does not need to be hingedly mounted in order to move it out of engagement with the catch plate as full disengagement achieved through the angled path of the latch hook. The latch body, latch slider and catch plate can therefore be provided internally to a case, with the actuation means provided externally, where they are protected from damage and tampering. A case latch assembly which can be installed and operated with the latch body, latch slider and catch plate concealed and protected within a case is thereby provided.

Preferably, the latch arm comprises a non-planar element of a resiliently flexible material and forms the resilient biasing means. The latch arm most preferably has an angled shaped and is formed from spring steel. The latch arm thereby both carries the latch hook and acts as the tension member for the latch slider.

The case latch assembly preferably further comprises a mounting dish on which the latch body is mounted, and which is adapted to be mounted on a case, most preferably on an internal surface of a case.

The latch body preferably defines a latch slider channel within which the latch slider is generally provided, the latch aperture and the latch actuation ramp being provided at one end of the channel. The latch slider channel is preferably provided between the mounting dish and the latch body, to form a substantially enclosed channel in which the latch slider is provided.

The movement of the latch slider is thereby contained within the latch slider channel.

The latch actuation means preferably comprises a mechanical cam actuation means, and most preferably comprises a cam coupled to a cam follower provided on the latch slider, and a manually operable actuation key coupled to the cam. The actuation key is preferably carried by the mounting dish and is arranged to at least partly extend externally to a case on which the latch assembly is mounted.

The latch actuation means can thereby be operated from the outside of a case on which the case latch assembly is mounted, while the latch body, latch slider and catch plate remain concealed and protected within the case.

The case latch assembly preferably further comprises a latch dish front member adapted to be mounted on the mounting dish and to be located on the external side of the case, the latch dish front member comprising a collar member adapted to surround the latch actuation key. The latch dish front member provides protection for the latch actuation key from accidental damage and operation.

The catch plate preferably comprises a catch aperture adapted to receive at least part of the latch hook therethrough and a catch hook adapted to engage with the latch hook.

The case latch assembly may further comprise a latch guard adapted for location generally over the catch plate and the latch hook. The latch guard prevents fouling of the latch hook and latch slider by the contents of the case, thereby ensuring that the latch slider is free to move and to allow the case latch assembly and the case to be opened.

### BRIEF DESCRIPTION OF THE SEVERAL VIEWS OF THE DRAWINGS

FIG. 1 is a plan view of a case latch assembly (without the catch plate) according to an embodiment of the invention.

FIG. 2 is a side view of the case latch assembly of FIG. 1.

FIG. 3 is an exploded view of the case latch assembly of FIG. 1.

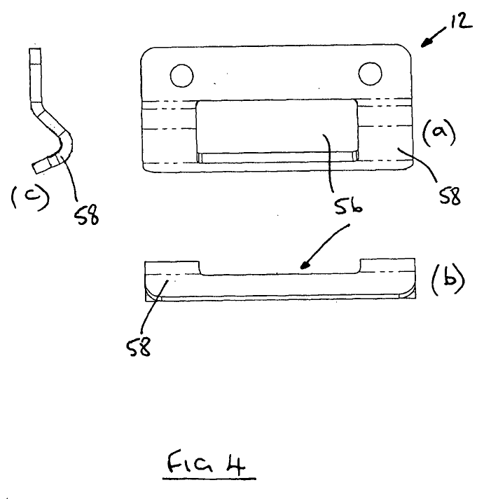

FIG. 4 shows the catch plate of the case latch assembly of FIG. 1, a) in plan, b) from the front, and c) from the side.

FIG. 5 shows cross-sectional views through the end of the latch body, latch arm and latch hook of FIG. 1 and the catch plate of FIG. 4, with the latch hook and arm in a) the closed position and b) the open position.

### DETAILED DESCRIPTION OF THE INVENTION

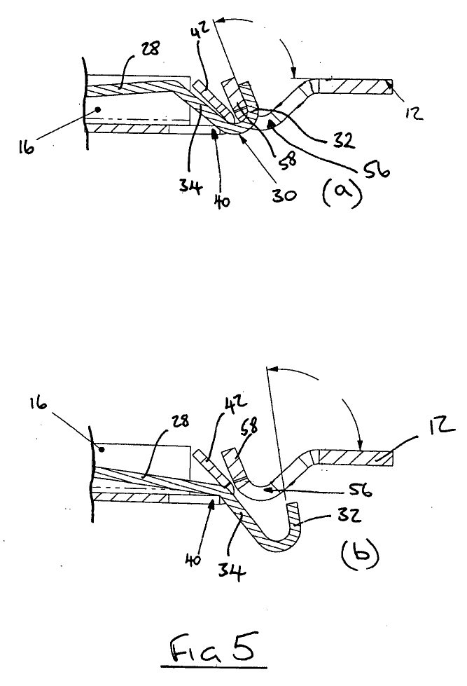

Referring to the drawings, a case latch assembly 10 according to an embodiment of the invention comprises a catch plate 12 (FIG. 4), a latch slider 14, a latch body 16, latch actuation means 18, a latch dish 20, a latch dish front 22 and a latch guard 24.

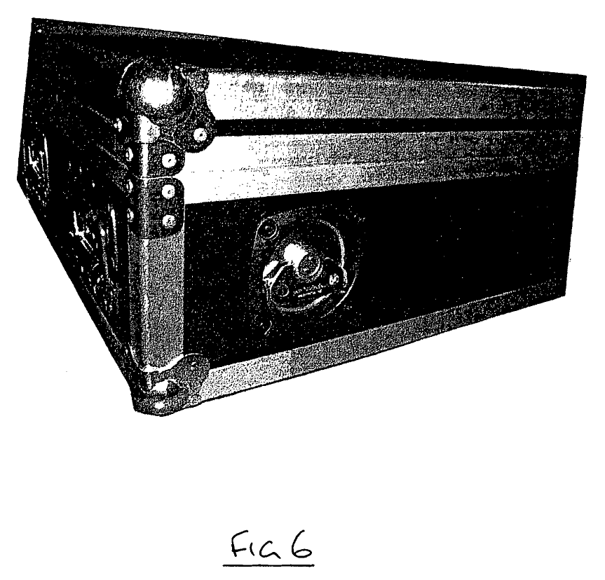

The latch slider 14 comprises a slider body 26, latch arm 28 and a latch hook 30 provided at the distal end of the arm 28. The latch slider 14 is formed from a single piece of sheet spring steel. The latch arm 28 has an angled shape and thereby acts as resilient biasing means for the latch slider 14. The latch hook 30 (as shown best in FIG. 5) comprises a hook member 32, adapted to engage the catch plate 12, and a latch hook ramp 34, by which the hook member 32 is coupled to the latch arm 28.

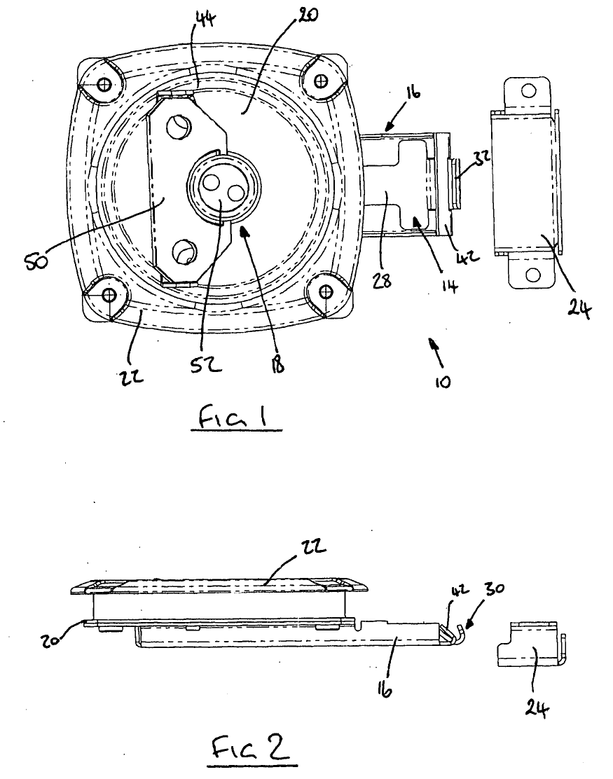

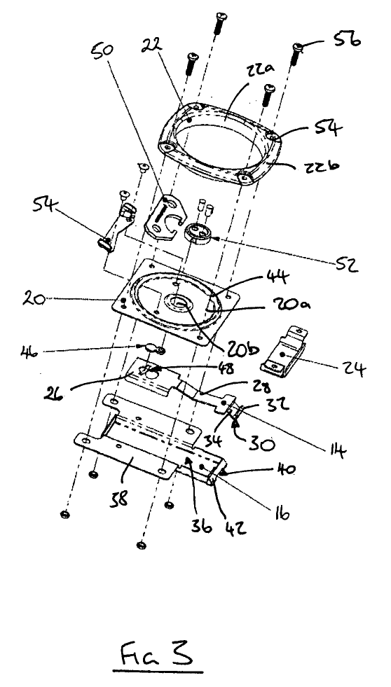

The latch body 16 comprises a latch slider channel 36, adapted to receive the latch slider 14, and mounting flanges 38 for coupling the latch body 26 to the latch dish 20. The latch body 16 is provided with a latch aperture 40 at one end of the slider channel 36. The latch hook 30 is at least partly received through the latch aperture 40, as shown in FIGS. 1, 2 and 5. The latch body 16 also comprises a latch actuation ramp 42, provided generally across the latch aperture 40 and adapted to engage the latch hook ramp 34.

The latch dish 20 is adapted to have the latch body 16 mounted on one side (the underside as shown in FIG. 5) and to be mounted on the internal surface of a case on its other (upper) side. A ring wall 44 is provided on the upper side of the latch dish 20 and is adapted to be located through a correspondingly sized circular hole formed in a wall of a case. The central area 20a of the latch dish 20 is thereby visible from the outside of the case. A central aperture 20b is formed in the latch dish 20.

The latch actuation means 18 comprises a mechanical cam 46 coupled to a cam follower 48 provided on the slider body 26, and an actuation key 50. The key 50 is coupled to the cam 46 via a lock nut 52. A key support 54 is provided on the latch dish 20, to keep the key 50 raised off the latch dish 20 so that a user can easily lift the key 50 into its operational position. The construction and operation of the latch actuation means 18 will be well known to the person skilled in the art.

The latch dish front 22 comprises a generally circular shaped collar having a wall 22a and a flange 22b. The collar wall 22a is of a complementary size and shape to the ring wall 44 on the latch dish 20, so that the collar wall 22a closely receives the ring wall 44. Fixing apertures 54 for receiving fixing screws 56 are provided in the flange 22b, by which the latch dish front 22 may be fixed, through corresponding apertures provided in the wall of a case, to the latch dish 20. The latch dish front 22 provides protection for the latch actuation means 18 from accidental damage, since the actuation key 50 is fully received within the latch dish front 22 when it is folded down (as shown in the Figures).

The catch plate 12 is provided with a catch aperture 56 adapted to receive at least part of the latch hook 30 and a catch hook 58 adapted to engage with the latch hook 30 when the latch hook 30 is in the closed position, as shown in FIG. 5(a).

The latch guard 24 is shaped to receive and be located over the catch plate 12, and the end of the latch body 16, including the latch hook 30. The latch guard 24 is provided with fixing apertures by which the latch guard 24 may be fixed onto the internal surface of the case lid.

As shown in FIG. 6, when the case latch assembly 10 is installed on a case 60, only the dish front 22, central area 20a of the latch dish 20, and the key 50 are located externally to the case 60, all the remaining parts of the case latch assembly 10 are located within the case 60 and are thereby concealed and protected from damage and tampering.

In operation, a user manually lifts the actuation key 50 into an upright position in which the user can manually rotate the key 50, to operate the cam actuation means 18. Operation of the cam actuation means 18 causes the latch slider 14 to be moved along the slider channel 36, in the direction away from the latch dish 20 (towards the catch plate 12) and towards the latch aperture 40 and the latch actuation ramp 42. As the latch slider 14 is moved, the latch hook ramp 34 is pushed towards and engages against the latch actuation ramp 42. Due to the angled shapes of the ramps 34, 42, the latch actuation ramp 42 exerts a downwards force (as orientated in the drawings) on the latch hook ramp 34, which pushes the latch hook 30 generally downwards and away from the latch actuation ramp 42, and causes the latch arm 28 to flex downwards toward the latch body 16. Continued actuation of the cam actuation means 18 causes the latch hook 30 to move from its closed position (FIG. 5a) towards its open position (FIG. 5b), the latch hook 30 travelling through the latch aperture 40 and following an angled, downwards path away from the latch body 16. The latch hook 30 is thereby fully disengaged from and removed from the catch plate 12, and the case is free to be opened.

If the actuation key 50 is released, or manually rotated back to its starting position, the latch hook 30 moves in an upwardly angled path that brings it into engagement with the catch hook 58. The tension provided by the latch arm 28, in its capacity as resilient biasing means, retains the latch hook 30 in engagement with the catch hook 58, thereby keeping the latch assembly, and the case on which it is installed, closed.

Various modifications may be made to the described embodiment without departing from the scope of the invention. For example, the resilient biasing functionality of the latch arm may be provided by separate resilient biasing means coupled to the latch arm, and the lath arm may have a different shape to that shown in order to provide it with its resilient biasing functionality. The dish and the dish front may be of a different shape, for example non-circular, although the use of the circular shape in the described embodiment offers the advantage that a circular hole can be provided through the case (circular holes being the easiest shape to cut). A different type of actuation means may be used to that described. It will be appreciated that the latch guard may be dispensed with in certain applications.

1. A case latch assembly (10) comprising:
a. a catch plate (12);
b. a latch slider (14) comprising a latch arm (28) and a latch hook (30) provided at the distal end thereof, and resilient biasing means adapted to retain the latch hook in a closed position, in which the latch hook can engage the catch plate;
c. a latch body (16) adapted to receive at least part of the latch slider; and
d. latch actuation means (18) operable to cause the latch hook to move between the closed position and an open position in which the latch hook is removed from the catch plate,
wherein the latch hook comprises a hook member (32) adapted to engage the catch plate and coupled to the latch arm by a latch hook ramp (34), and the latch body is provided with a latch aperture (40) through which the latch hook is at least partly received and a latch actuation ramp (42) provided generally across the latch aperture and adapted to engage the latch hook ramp, such that as the latch hook is moved from the closed position towards the open position the latch hook moves through the latch aperture and the latch actuation ramp engages the latch hook ramp and forces the latch hook to follow an angled path away from the latch body.

2. The case latch assembly of claim 1, wherein the latch arm comprises a non-planar element of a resiliently flexible material and forms the resilient biasing means.

3. The case latch assembly of claim 1, wherein the case latch assembly further comprises a mounting dish (20) on which the latch body is mounted, and which is adapted to be mounted on a case.

4. The case latch assembly of claim 2, wherein the case latch assembly further comprises a mounting dish (20) on which the latch body is mounted, and which is adapted to be mounted on a case.

5. The case latch assembly of claim 2, wherein the latch body defines a latch slider channel (36) within which the latch slider is generally provided, the latch aperture and the latch actuation ramp being provided at one end of the channel.

6. The case latch assembly of claim 3, wherein the latch body defines a latch slider channel (36) within which the latch slider is generally provided, the latch aperture and the latch actuation ramp being provided at one end of the channel.

7. The case latch assembly of claim 4, wherein the latch body defines a latch slider channel (36) within which the latch slider is generally provided, the latch aperture and the latch actuation ramp being provided at one end of the channel.

8. A case latch assembly as in any of the preceding claims, wherein the latch actuation means (18) comprises a mechanical cam actuation means comprising a cam (46) coupled to a cam follower (48) provided on the latch slider, and a manually operable actuation key (50) coupled to the cam.

9. A case latch assembly as claimed in claim 8, wherein the actuation key is carried by the mounting dish and is arranged to at least partly extend externally to a case on which the latch assembly is mounted.

10. A case latch assembly as in any one of claims 3-7, wherein the actuation key is carried by the mounting dish and is arranged to at least partly extend externally to a case on which the latch assembly is mounted.

11. A case latch assembly as claimed in any one of claims 3-7, wherein the case latch assembly further comprises a latch dish front member (22) adapted to be mounted on the mounting dish and to be located on the external side of the case, the latch dish front member comprising a collar member (22a) adapted to surround the latch actuation key.

12. A case latch assembly as in any one of claims 3-7, wherein the catch plate comprises a catch aperture (56) adapted to receive at least part of the latch hook therethrough and a catch hook (58) adapted to engage with the latch hook.

13. A case latch assembly as in any one of claims 3-7, the case latch assembly further comprises a latch guard (24) adapted for location generally over the catch plate and the latch hook.

14. A case latch assembly (10) comprising:
a. a catch plate (12);
b. a latch slider (14) comprising a latch arm (28) and a latch hook (30) provided at the distal end thereof, and wherein the latch arm comprises a non-planar element of a resiliently flexible material, and forms a resilient biasing means adapted to retain the latch hook in a closed position, in which the latch hook can engage the catch plate;
c. a latch body (16) adapted to receive at least part of the latch slider;
d. latch actuation means (18) comprising a mechanical cam actuation means comprising a cam (46) coupled to a cam follower (48) provided on the latch slider, and a manually operable actuation key (50) coupled to the cam, the latch actuation means operable to cause the latch hook to move between the closed position and an open position in which the latch hook is removed from the catch plate, and
e. a mounting dish (20) on which the latch body is mounted, and which is adapted to be mounted on a case, wherein the actuation key is carried by the mounting dish and is arranged to at least partly extend externally to a case on which the latch assembly is mounted,
wherein the latch hook comprises a hook member (32) adapted to engage the catch plate and coupled to the latch arm by a latch hook ramp (34), and the latch body is provided with a latch aperture (40) through which the latch hook is at least partly received and a latch actuation ramp (42) provided generally across the latch aperture and adapted to engage the latch hook ramp, such that as the latch hook is moved from the closed position towards the open position the latch hook moves through the latch aperture and the latch actuation ramp engages the latch hook ramp and forces the latch hook to follow an angled path away from the latch body, and wherein the latch body defines a latch slider channel (36) within which the latch slider is generally provided, the latch aperture and the latch actuation ramp being provided at one end of the channel.

15. The case latch assembly of claim 14, wherein the case latch assembly further comprises a latch dish front member (22) adapted to be mounted on the mounting dish and to be located on the external side of the case, the latch dish front member comprising a collar member (22a) adapted to surround the latch actuation key.

16. The case latch assembly of claim 14, wherein the catch plate comprises a catch aperture (56) adapted to receive at least part of the latch hook therethrough and a catch hook (58) adapted to engage with the latch hook.

17. The case latch assembly of claim 14, the case latch assembly further comprises a latch guard (24) adapted for location generally over the catch plate and the latch hook.
